(19) United States
(12) Patent Application Publication
(10) Pub. No.: US 2015/0219929 A1
(43) Pub. Date: Aug. 6, 2015

(54) TREATMENT OF AMBLYOPIA

(71) Applicant: Prof Joshua David SILVER, Oxfordshire (GB)

(72) Inventor: Joshua David Silver, Oxfordshire (GB)

(21) Appl. No.: 14/428,664

(22) PCT Filed: Sep. 18, 2013
(86) PCT No.: PCT/GB2013/052448

§ 371 Date: Mar. 17, 2015

(30) Foreign Application Priority Data
Sep. 18, 2012 (GB) 1216600.5

(51) Int. Cl. G02C 7/08; G02C 7/10

(52) U.S. Cl. CPC G02C 7/081; G02C 7/085; G02C 7/083; G02C 7/10

(57) ABSTRACT

A patient with amblyopia is treated using a pair of shutter glasses (100). The shutter glasses (100) have first (104b) and second (106b) shutters and respective first (104c) and second (106c) variable focus lenses corresponding respectively to a lazy eye and a preferred eye of the patient. A power of at least one of the first (104c) or second (106c) variable focus lenses is adjusted. An opacity of the first shutter (104b) is controlled according to a first scheme. An opacity of the second shutter (106c) is controlled according to a second scheme. The first and second schemes are adhered to while the shutter glasses (100) are worn by the patient during a treatment period. The use of variable focus lenses together with shutters provides for a greater flexibility and improved procedures including correction of the refractive error in one or both eyes and/or using sub-optimal refractive powers as part of the treatment.

The invention relates to methods and apparatus for treatment of amblyopia. In particular, the preferred embodiments of the invention relate to the use of variable focus lenses and/or panes of variable opacity/transmissivity for the treatment of amblyopia.

Amblyopia can be described as the loss of one eye's ability to see details. It is the most common cause of vision problems in children and is relatively common, affecting perhaps 2% of children.

There are a number of different possible causes for the condition, including misaligned eyes or a difference in refractive error between the two eyes. However, the condition is in part neurological in that the brain selects one eye as a stronger (preferred) eye and uses the signals from that eye in preference to those of the weaker (“lazy”) eye. This may arise through the brain's inability to form a single coherent image from the two separate signals that it receives. The weaker eye is then to some extent (partially or fully) ignored and the brain/eye system for that eye can degrade or not develop properly. As a consequence, the subject's binocular vision is impaired or non-existent.

The conventional way to treat amblyopia is to patch the good eye so as to force the so-called “lazy eye” (i.e. the weaker or less-preferred eye) to function better. In reality this attempts to force the whole adaptive optical system of the lazy eye to function better. This sometimes works, but there are disadvantages to the use of patches. One major downside is that patches look odd. As amblyopia is most treatable during the eye/brain development stages, the patients are predominantly children. The effectiveness of the patching treatment depends to a large extent on the patient's compliance with the treatment programme. Therefore if a child (or other patient) is unwilling to wear a patch, e.g. due to discomfort or for social reasons, the treatment may be less effective or non-effective.

LCD Shutter glasses are known as one means to view video (e.g. film or television) in 3D, by displaying alternate left-eye frames and right-eye frames on a display and synchronising the shutter glasses to occlude each eye in turn so that each eye only views the frames intended for it. US 2001/0050754 describes the use of shutter glasses for the treatment of amblyopia by using the shutters to impair the vision of the stronger eye, thus forcing or encouraging the brain to make use of the weaker eye in much the same way as the conventional patching treatment. This provides a training effect on the weaker eye with the intention of improving the brain's use of and control of that eye, leading to improved vision. To adjust the transmissivity of the LCD lenses the LCD is transitioned between transparent and opaque states at frequencies sufficiently high that the patient will not see the discrete transitions.

WO 2011/098836 describes shutter glasses for viewing 3D television and incorporating variable focus lenses for correcting the user's vision so as to achieve optimal acuity without the need for separate prescription glasses or inserts.

U.S. Pat. No. 5,264,877 describes a pair of shutter glasses for diagnosing or treating certain malfunctions of the eye, including amblyopia. The shutter glasses are operable at frequencies in the range 4 cycles per minute to 15 Hz, with the shutters alternating between opaque and transparent states such that one shutter is opaque while the other is transparent and vice versa.

However, existing methods of treating amblyopia using eye patches, shutter glasses and other means require on-going treatment, sometimes for long, frequent treatment sessions over a long treatment period. Thus there remains a need for improved methods and apparatus for treating amblyopia.

According to a first aspect, the present invention provides a method of treating a patient with amblyopia using a pair of shutter glasses, the shutter glasses having first and second shutters and respective first and second variable focus lenses corresponding respectively to a lazy eye and a preferred eye of the patient, the method comprising:
adjusting a power of at least one of the first or second variable focus lenses;
controlling an opacity of the first shutter according to a first scheme;
controlling an opacity of the second shutter according to a second scheme;
adhering to the first and second schemes while the shutter glasses are worn by the patient during a treatment period.

The invention extends to a pair of shutter glasses for treating amblyopia, comprising:
a first shutter corresponding to a lazy eye, the glasses being configurable to control an opacity of the first shutter according to a first scheme;
a first variable focus lens corresponding to the first shutter;
a second shutter corresponding to a preferred eye, the glasses being configurable to control an opacity of the second shutter according to a second scheme; and
a second variable focus lens corresponding to the second shutter; wherein
at least one of said first and second schemes comprises maintaining an opaque state or a non-opaque for a duration greater than 0.05 seconds.

It will be appreciated that the preferred features set out below apply equally to both methods and apparatus.

Preferably the first and second schemes comprise maintaining an opaque state in one shutter and a non-opaque state in the other shutter for a duration greater than 0.05 seconds.

Thus according to the present invention, a user can configure the shutter glasses to maintain a state that is suitable for treating amblyopia. The user may be, for example, the patient, a medical practitioner, e.g. an optician, or a care provider of the patient. The step of adjusting at least one of the variable focus lenses advantageously allows the shutter glasses to be adjusted to suit most users having a refractive error in one or both eyes without the need to wear additional corrective eyeglasses or insertable prescription lenses which may not be immediately available and can take significant time to prepare. Variable focus lenses can be adjusted quickly for each patient. Additionally, there are other significant benefits to the provision of variable focus lenses which will be described more fully below.

The treatment period may be a training or assessment period. The treatment period may comprise a single continuous period. The treatment period may comprise a continuous period that is subsequently repeated during an extended period, e.g. a number of hours or minutes per day for a number of days or weeks.

The first and/or second schemes may comprise switching irregularly between two opacities. However, preferably the first and/or second schemes comprise switching between a first and second opacity at a fixed frequency, i.e. such that the first shutter is at the first opacity when the second shutter is at the second opacity and vice versa. The first and second opacities may be any appropriate degree of opacity, but in some preferred embodiments one state is fully transparent (non-opaque) and the other state is non-transparent (fully opaque). The fixed frequency is preferably between 1 and 20 Hz, more preferably between 1 and 10 Hz, however any suitable frequency may be used. In some embodiments, preferably the frequency is greater than 0 Hz. In some embodiments, preferably the frequency is less than the frequency at which the brain cannot detect flicker, i.e. in some cases, preferably less than 50 Hz. In some embodiments, at least one of said first and second schemes comprises maintaining an opaque state or a non-opaque state for a duration greater than 0.05 seconds, preferably much greater than 0.05 seconds, for example greater than one second, greater than five seconds, greater than one minute, greater than ten minutes, greater than one hour.

In some embodiments, the first scheme comprises maintaining the opacity of the first shutter at an opacity that is lower than an opacity of the second shutter for the duration of the treatment period. In some embodiments, the first scheme comprises maintaining the first shutter in a non-opaque state for the duration of the treatment period. In some embodiments, the second scheme comprises maintaining the second shutter in an opaque or partially opaque state for the duration of the treatment period. Thus the preferred eye's vision may be obscured or penalized, providing an effect similar to applying a patch over the preferred eye.

The shutter glasses can thus be used instead of conventional patching methods, such as eye patches. This provides improved comfort for the patient compared with e.g. an eye patch, as well as improved convenience as the lazy eye may be patched simply by switching the shutters according to the schemes, e.g. with a switch on the glasses, or according to a pre-set programme which can be set or selected by the user which the glasses may be configured to follow. The glasses also provide a more aesthetically pleasing means of patching an eye as the whole apparatus can take the form of a pair of eyeglasses with more traditional and socially acceptable appearance, e.g. including relatively normal frames and legs. This is advantageous as a large number of amblyopia patients are children, for whom the aesthetic appeal of their treatment may significantly influence their willingness to adhere to a treatment schedule.

Further, the shutter glasses can be used without separate prescription glasses, as might otherwise be required, e.g. for the preferred eye outside of the treatment period and/or for the lazy eye during the treatment period and other times, if a patch were used for a patient requiring refractive error correction. The patient can therefore use the same pair of eyeglasses during the treatment period and outside of the treatment period.

The state of each shutter may be adjustable by a user, e.g. the patient or a health professional, or may be programmable by a user. The first and second schemes may be pre-programmed in the shutter glasses. There may be provided means to select one of a number of pre-programmed schemes by the user. The state of or scheme applied to each shutter may be controlled remotely, e.g. via a wireless link or cable connection to a computer with a control interface. Programmes may be created and uploaded to the eyeglasses to allow customized schemes to be created for each patient if necessary.

As indicated above, the use of variable focus lenses provides more benefit than simply allowing optimum refractive correction for each eye. The variable focus lenses may in fact be used as part of the treatment of the lazy eye. The power of the variable focus lenses may be adjusted during, prior to or subsequent to a treatment period. In some embodiments, the first variable focus lens corresponding to the lazy eye is adjusted to a power corresponding to the optimum acuity of the lazy eye. This adjustment may be performed to determine the power corresponding to the optimum acuity of the lazy eye. The first variable focus lens may be maintained at the power corresponding to the optimum acuity of the lazy eye during some or all of the treatment period. The power of the second variable focus lens may be adjusted, for example, to achieve the optimum acuity for the preferred eye. This may be useful, for example, during periods when the lazy eye is not being trained or assessed or during treatment periods when the preferred eye is not continuously obscured.

In some preferred embodiments, the second variable focus lens is adjusted to a power corresponding to a sub-optimal acuity of the preferred eye. The variable focus lens for the preferred eye may thus be used to penalise the preferred eye instead of (or in combination with) using a patch or reduced transparency. For example, a sub-optimum acuity can be used to blur the vision in the preferred eye. Preferably, the acuity of the preferred eye is set lower than that of the lazy eye. The use of a lens to blur vision may have social benefits as well as treatment benefits, e.g. it may provide a better appearance than a patch or opaque lens. The sub-optimum acuity may be maintained during some or all of the treatment period.

This is believed to be novel and inventive in its own right, thus when viewed from a second aspect the invention provides a method of treating a patient with amblyopia using a pair of glasses, the glasses comprising a variable focus lens corresponding to a preferred eye, the method comprising:
adjusting the variable focus lens to a power corresponding to a sub-optimal acuity of the preferred eye; and
maintaining the variable focus lens at the power corresponding to the sub-optimal acuity during some or all of a treatment period.

Preferably the glasses also comprise a further variable focus lens corresponding to a lazy eye. Preferably the sub-optimal acuity set for the preferred eye is worse than an optimal acuity of the lazy eye.

In some embodiments of either of the aspects above, the power of the variable focus lens corresponding to the lazy eye may be varied during the treatment period.

This is believed to be novel and inventive in its own right, thus when viewed from a third aspect, the invention provides a method of treating a patient with amblyopia using a pair of glasses, the glasses comprising a variable focus lens corresponding to a lazy eye, the method comprising varying a power of the variable focus lens during a treatment period.

This aspect of the invention extends to a pair of glasses for treating a patient with amblyopia, the glasses comprising:
a variable focus lens corresponding to a lazy eye;
controlling means configurable to automatically vary a power of the variable focus lens during a treatment period.

The controlling means may be programmable.

Preferably the glasses also comprise a variable focus lens corresponding to a preferred eye.

The power of the lazy eye's variable focus lens may be varied, for example, discretely, periodically, or randomly, however preferably the variable focus lens for the lazy eye is swept continuously in and out of focus. The continuous variation of the lens may be sinusoidal. Preferably the method comprises the step of determining an optimum power of the lens corresponding to an optimum acuity of the lazy eye. Alternatively, the power required for achieving optimum acuity may already be known. The power of the variable focus lens preferably sweeps between a power lower than the best corrective power and a power higher than the best corrective power. It will be appreciated that sweeping in either or both directions may be used as part of the treatment. In some preferred embodiments, the sweep is symmetrical either side of the best corrective power.

The range over which the power of the variable focus lens is swept may take any value, but is preferably a range of about six dioptres, e.g. between 3 dioptres above the best corrective power for the patient's eye (i.e. the power that gives best acuity) and 3 dioptres below the best corrective power. It is believed that for many, although not all, amblyopes, the “lazy” eye becomes hyperopic with a power of around 3 dioptres. A suitable sweeping range in many cases is thus 0 to 6 dioptres, so that as the lens power is varied, the power sweeps through the best corrective power for the eye, preferably from both directions.

A wide range, such as 6 dioptres, may advantageously enhance the treatment of the eye. In some case a wider range, for example, about 8 dioptres, about 10 dioptres, or higher, may be used. This may allow a patient to be treated if the best corrective power of the lazy eye is not known, or known only approximately, as the treatment can be applied with a wide range making a reasonable assumption that the best corrective power lies somewhere in the sweep range.

However, a narrower range may also be used. For example, if a patient's best corrective power is known, a sweep range of less than 6 dioptres could be used, for example, 2 dioptres (e.g. 1 dioptre either side of the best corrective power) or even 1 dioptre (e.g. 0.5 dioptre either side of the best corrective power). This may be advantageous if variable focus lenses are used with a mechanism for varying the power that only works (or works best) for small ranges.

The sweep range may be symmetric about the best refractive power, i.e. the middle value of the sweep range is substantially equal to the best refractive power, e.g. 0 to 6 dioptres for a best refractive power of 3 dioptres. The sweep range may be asymmetric about the best refractive power, e.g. a range of −1 to 5 dioptres for a best refractive power of 2.5 dioptres. The best refractive power may be substantially equal to an end value of the range, e.g. a range of 1 to 7 dioptres for a best refractive power of 1 dioptre, or −3 to 3 dioptres for a best refractive power of 3 dioptres.

The rate at which the first variable focus lens is swept in and out of focus may take any value, however preferably the first variable focus lens is swept at a rate of about one dioptre per second. Any number of sweeps may be used in a treatment period, however preferably the first variable focus lens is swept in and out of focus between 50 and 150 times, e.g. 100 times. Preferably the procedure of carrying out multiple sweeps of the power is repeated periodically, e.g. once a day, for an extended period, e.g. for a month.

In some embodiments, the refractive error and/or acuity of the patient's lazy eye is measured once, or more than once, before, during, or after the or an extended period. The patient's binocular vision may be assessed to determine how well the patient can merge images from their lazy and preferred eyes. This assessment may be carried out once, or more than once, before, during, or after the or an extended period. A further procedure or series of procedures may be carried out on the basis of the assessment of the patient's binocular vision and/or the measurement of refractive error and/or acuity of the patient's lazy eye.

In accordance with any of the aspects described above, the use of shutters may be combined with the use of sweeping the power of a variable focus lens in a combined treatment. For example, the patient's preferred eye may be obscured or penalised using a shutter while the sweeping treatment is applied to the lazy eye. Alternatively or in addition the shutters may be used to alternate between the preferred eye and the lazy eye, while the power of the first variable focus lens is swept in and out of focus. The sweeping of the variable focus lens may be performed on a substantially different timescale from the shuttering. For example the shuttering may occur at a frequency of around 10 Hz, while the variable focus lens sweeps in and out of focus around once every ten seconds.

Penalisation of the preferred eye may involve a continuous opaque state, a continuous partial opaque state or high frequency rapid transitions between opaque/non-opaque states with the duty cycle defining the level of opacity. The preferred arrangement will depend on the type of shutter being used and the choice of power and control mechanisms. In some preferred embodiments LCD shutters are used due to their ready availability, cost and low power requirements. However other variable transmissivity/opacity panes may be used.

In some embodiments, the patient may partake in an activity during some or all of the treatment period. The activity may encourage use of the lazy eye, or may encourage concentration of the patient during the treatment period. For example, the patient may view or attempt to view symbols on a wall chart or display (e.g. a Snellen chart, LEA chart or tumbling E chart). The patient may play a computer game or watch a video.

Glasses that are provided with shutters may also be suitable for use with a stereoscopic display, e.g. a 3D television. For example, the shutter glasses may comprise means for synchronising the shutters with the stereoscopic display. The glasses may be configured to be operable at a frequency that is compatible with 3D displays, e.g. 50 Hz or 60 Hz. The shutter glasses may then conveniently be used to view 3D media when they are not in use for treating the patient's amblyopia.

Alternatively or in addition, 3D media may be used in conjunction with or as part of the patient's treatment.

Glasses comprising variable focus lenses may be adjusted for use as conventional corrective eye glasses when they are not used for treating amblyopia. Thus glasses in accordance with the present invention may be used for the dual purpose of treating amblyopia and providing corrected vision at other times. Additionally, the availability of both variable focus lenses and shutters configurable for use with 3D displays allows users to correct their vision and view 3D displays with a single pair of eyeglasses, providing a more convenient and pleasurable viewing experience.

The variable focus lens may comprise a fluid filled lens, an Alvarez-based lens, an electro-active lens, a diffractive lens or a diffractive Alvarez lens. The range over which the power of a variable focus lens can be varied may depend on the type of variable focus lens and/or on the particular construction of the particular lens. For example, fluid-filled lenses may be provided with external tubes containing liquid, which may allow variation over a greater power range than for example a pair of fluid-filled glasses containing some liquid within the frames for fine-tuning of the power. Any suitable type or construction of variable focus lens may be used.

In some embodiments, the variable focus lenses provide the necessary range of adjustment of the lens, i.e. the adjustment range is large enough to suit the majority of patients. However, in some embodiments each variable focus lens may be provided with one or more fixed power lens elements. Such a fixed power lens element allows a different range of powers to be achieved using the variable focus lens, facilitating accommodation of a greater range of powers and thus making the apparatus suitable for a greater number of users. The use of fixed power lens elements also allows for the correction of other deficiencies in the patient's vision, e.g, astigmatism, that may be difficult or impossible to correct using variable focus lenses. The use of fixed power lens elements may also be advantageous in embodiments employing sweeping of the power of a variable focus lens. The additional power of a fixed power lens may be used to provide powers that are difficult or impossible to achieve with some kinds of variable focus lenses.

Viewed from another aspect, the invention there is provided eyeglasses for treatment of amblyopia, comprising:
left and right shutters with controllable opacity; and
left and right variable focus lenses;
wherein the left and right shutters are controllable to impair the vision of one eye with respect to the other eye for one or more continuous periods of greater than 0.05 seconds.

Viewed from yet another aspect, the invention provides a method of treatment of a patient with amblyopia, comprising:
providing the patient with eyeglasses having left and right shutters with controllable opacity and left and right variable focus lenses;
adjusting the focus of one or both variable focus lenses;
controlling the opacity of the left and right shutters;
wherein one or both of the adjusting and controlling steps impairs the vision of the non-amblyopic eye.

The vision of the non-amblyopic eye may be impaired by patching, darkening or blurring. The amblyopic eye may also be impaired, statically or dynamically.

Viewed from a further aspect, the invention provides eyeglasses which are equipped with both LCD lenses whose transmissivity may be controlled (or other variable transmissivity panes/lenses), and adaptive lenses whose power may be varied, e.g. by the wearer, or by an eyecare practitioner.

Certain preferred embodiments will now be described, by way of example only, with reference to the accompanying drawings, in which:

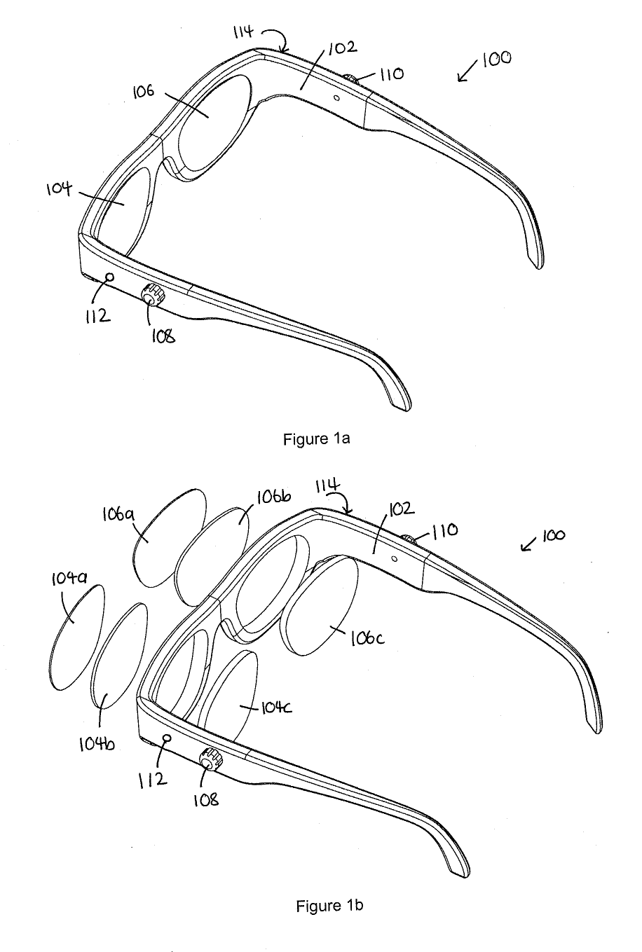

FIG. 1a shows a perspective view of an embodiment of a pair of shutter glasses in accordance with the present invention.

FIG. 1b shows a perspective view of the embodiment of FIG. 1a with the lenses of the shutter glasses shown in an exploded view.

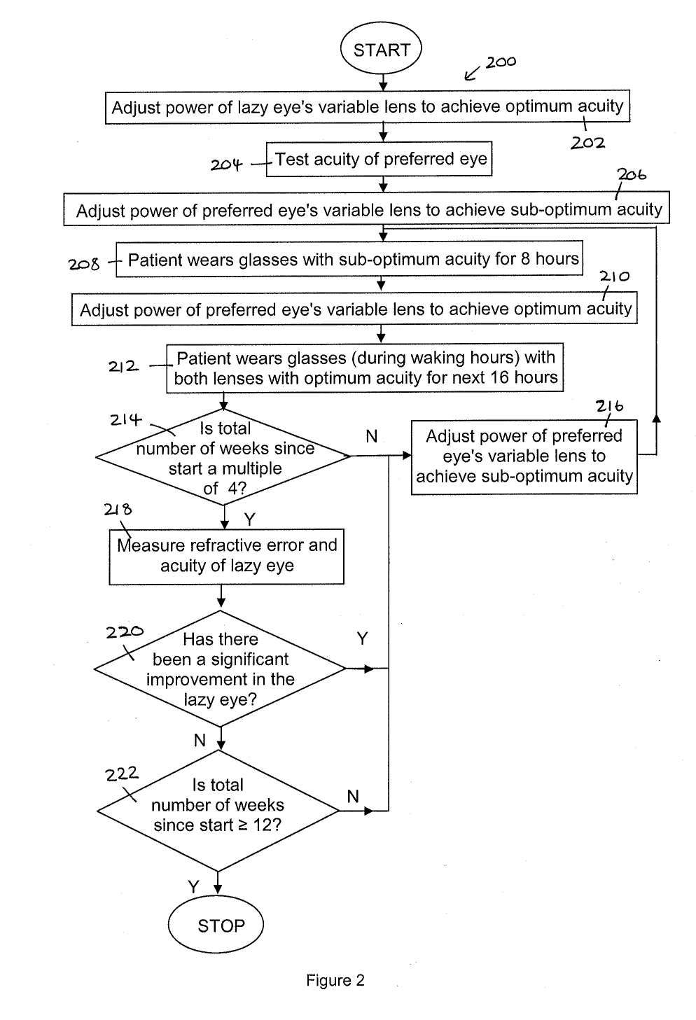

FIG. 2 shows a method of treating amblyopia in accordance with the present invention, wherein a patient wears a pair of variable focus glasses with a variable focus lens at a power corresponding to a sub-optimum acuity of the patient's preferred eye.

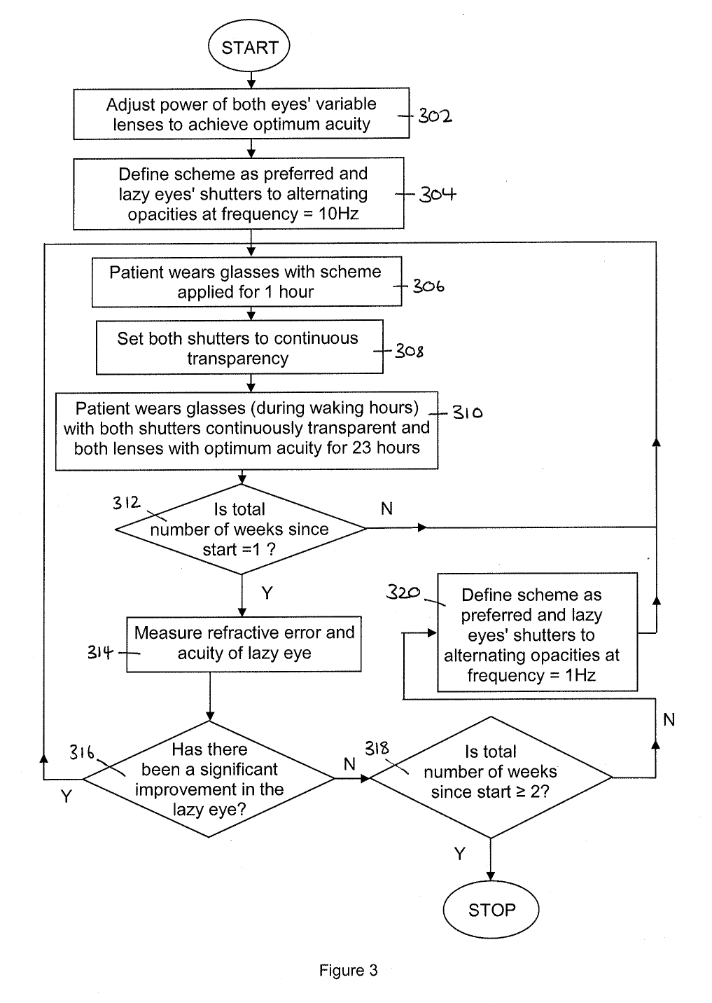

FIG. 3 shows a further method in accordance with the present invention, wherein a patient wears a pair of shutter glasses with alternating transparency and opacity.

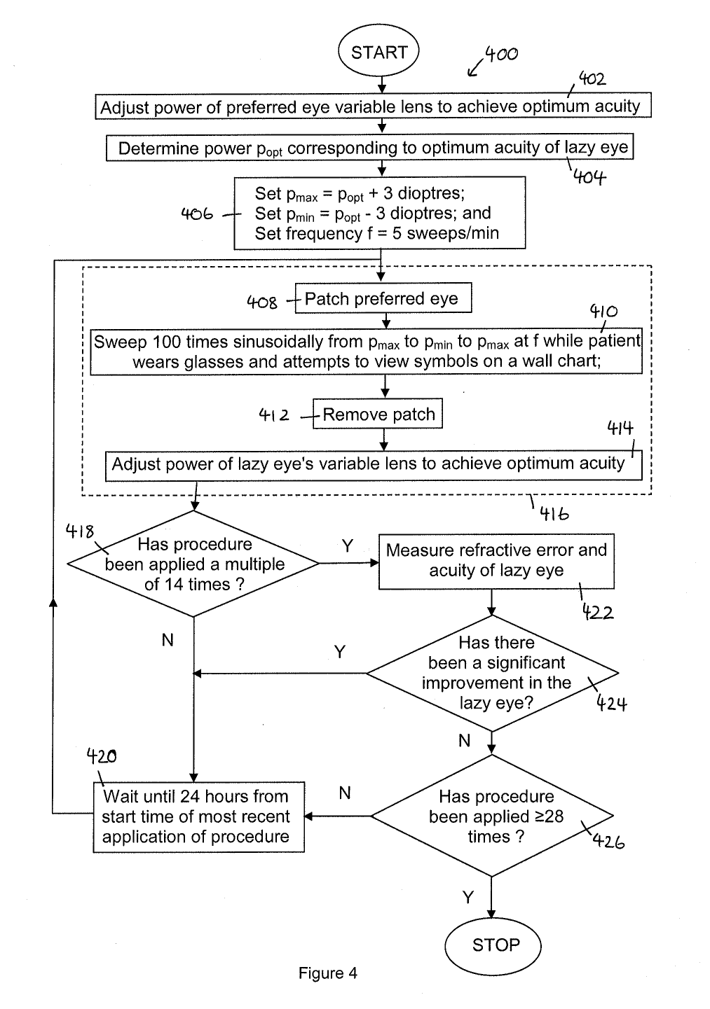

FIG. 4 shows another method in accordance with the present invention, wherein a variable focus lens is swept periodically between a maximum and minimum power during a treatment period.

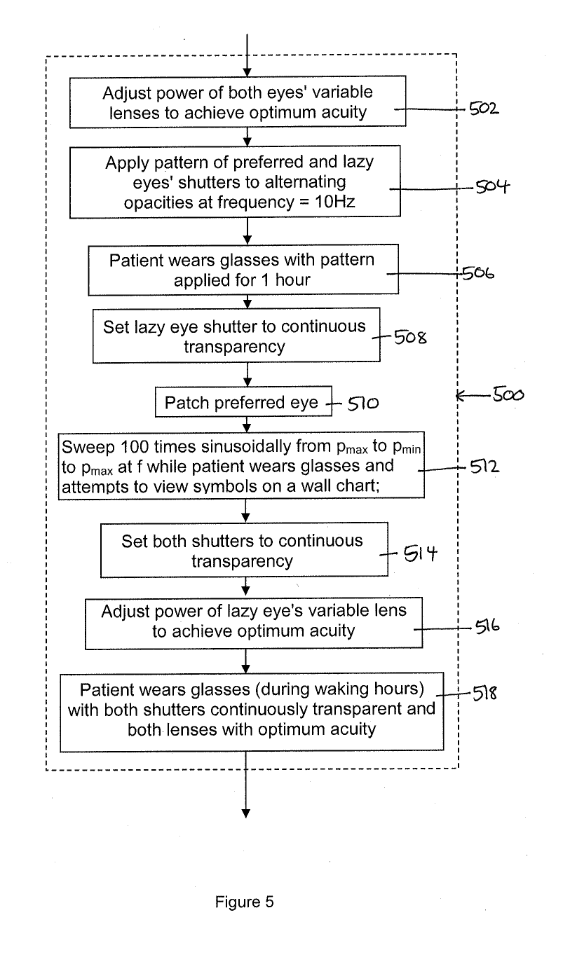

FIG. 5 shows an alternative procedure that may be used in place of the procedure used in the method of FIG. 4, the alternative procedure comprising alternating the shutter transparency and opacity and subsequently sweeping a power of a variable focus lens.

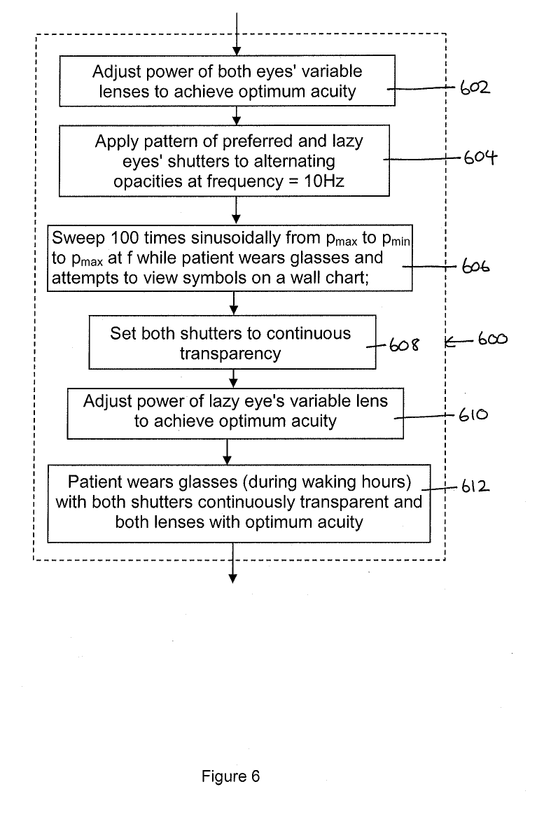

FIG. 6 shows a further alternative procedure that may be used in place of the procedure used in the method of FIG. 4, the further procedure comprising simultaneously alternating shutter transparency and opacity and sweeping a power of the variable focus lens from a maximum to minimum value.

FIG. 1a shows an embodiment of a pair of shutter glasses 100 in accordance with the present invention. The shutter glasses 100 comprise a frame 102 to allow the glasses 100 to be worn by a patient in the same manner as a conventional pair of glasses. Mounted in the frame 102 are left 104 and right 106 composite lenses. FIG. 1b shows the embodiment of FIG. 1a with the composite lenses depicted in an exploded view. The composite lenses each comprise a protective front piece 104a, 106a, a shutter 104b, 106b and a variable focus lens 104c, 106c. The protective front piece may be a fixed prescription lens, or may have no prescription and be provided solely for protection of the shutters 104b, 106b and variable focus lenses 104c, 106c.

On the sides of the frame 102 are provided left 108 and right 110 rotatable knobs which may be turned to vary the power of the variable focus lenses 104c, 106c. In the present embodiment, the rotatable knobs 108, 110 may be turned to vary the power of lenses 104c, 106c independently.

Also provided on the sides of the frame 102 are left 112 and right 114 buttons for controlling an opacity state of the shutters. In the present embodiment the buttons 112 and 114 allow independent control of the shutters 104b, 106b in each composite lens 104, 106. The buttons 112, 114 allow a user to toggle each shutter 104b, 106b between an opaque state and a translucent state. However it will be appreciated that in other embodiments means for a user to continuously vary the capacity of the shutters 104b, 106b, independently or otherwise, may be provided.

Internal to the frame 102 is provided a receiver and an internal processor. The receiver receives a signal from a remote computer containing information relating to a scheme for varying the transparency of the shutters 104b, 106b. The processor includes a memory in which data relating to the scheme is stored. The internal processor of the glasses 100 thus operates the shutters according to the scheme. A user at a remote computer may thus configure the glasses 100 to apply a scheme during a treatment period. It will be appreciated that in other embodiments means for providing a scheme to the glasses by a user may be provided on the glasses themselves, or via a cable connection to the glasses, or by any other suitable means. The user may also use the remote computer to set one or more of the shutters in a continuous opaque or transparent state. In this embodiment, the scheme comprises switching the left and right shutters 104b, 106b alternately between an opaque state and a transparent state at a fixed frequency. However in other embodiments other schemes are possible. In general, the scheme may comprise a first scheme for one shutter 104b and a second scheme for the other shutter 106b. The two schemes are preferably synchronised.

In some embodiments, in addition to or instead of the rotatable knobs 108, 110, the variable focus lenses 104c, 106c may be provided with actuating means for varying the power thereof, where the actuating means is controlled by remote and/programmable controlling means. The actuating means (e.g. a motor) could be operable or programmable by means of an internal processor and memory in the same way as the shutters of the present embodiment.

FIG. 2 shows a method 200 of treating a patient with amblyopia according to the present invention. The method 200 is applied using a pair of shutter glasses with variable focus lenses in accordance with the present invention. The first step 202 comprises adjusting the power of the lazy eye's variable focus lens to achieve optimum acuity of the lazy eye. It is convenient to adjust the variable focus lens for the lazy eye at this stage, however it could be adjusted subsequently or not at all.

The second step 204 comprises testing the acuity of the preferred eye. This may be achieved by adjusting the power of the variable focus lens of the preferred eye until an optimum acuity is achieved. It will be appreciated however that other methods of testing the acuity of the preferred eye could be employed.

The third step 206 comprises adjusting the power of the preferred eye's variable focus lens to achieve a sub-optimum acuity. This could be achieved by adjusting the power to cause blurring of vision in the preferred eye.

At step 208 the patient wears the glasses with the power of the preferred eye's variable focus lens corresponding to a sub-optimum acuity for a period of eight hours. It will be appreciated that other durations for this step in the procedure could be employed.

The sub-optimum acuity for the preferred eye is preferably selected to be worse than the acuity of the lazy eye. During this period, the acuity of the lazy eye is better and thus the brain is encouraged to make use of the signal from this eye, thus training the eye/brain system.

At step 210, the power of the lens of the preferred eye is adjusted to achieve optimum acuity.

At step 212, the patient wears the glasses with both variable focus lenses at powers corresponding to optimum acuity for 16 hours. The patient may of course remove their glasses during some activities, e.g. sleep, washing and showering, sports, etc.

It will be appreciated that in accordance with steps 208, 210 and 212, the duration of one cycle of wearing the sub-optimum acuity glasses followed by wearing optimum acuity glasses lasts one day. Thus in accordance with the present embodiment, the procedure is repeated daily. Other cycle lengths may be suitable. At step 214, it is determined whether a patient has reached the end of a four week period of daily treatments. If the patient has not yet worn the glasses for a period of four weeks, the glasses are adjusted back to a state of having the preferred eye's variable focus lens at a power corresponding to a sub-optimum acuity, and the daily procedure is repeated, recommencing at step 208.

If the patient has completed four weeks of treatment, at step 2218 an optician or other medical professional measures the refractive error and acuity of the lazy eye to determine whether there has been any improvement during the treatment. In accordance with step 220, if there has been no significant improvement in the lazy eye, it is then determined at step 222 whether the duration of treatment has reached 12 weeks. If no improvement has yet been seen before 12 weeks has elapsed, it is desirable to continue the treatment in the hope of observing an improvement subsequently. Thus if the treatment has not yet lasted 12 weeks, the method returns to steps 216 and 208, thus applying the treatment procedure daily for a further four weeks. If there has been a significant improvement in the lazy eye following the first four-week period of treatment, the method returns to step 208 for a further four weeks treatment in anticipation of observing a further significant improvement. If after one or more subsequent four-week treatments, no significant improvement, or no further significant improvement, is observed in the lazy eye and the total number of weeks since the start of treatment is greater than 12 the treatment is discontinued.

If the treatment is discontinued before any significant improvement in the lazy eye is seen, the medical practitioner may consider alternative methods of treatment for the patient.

FIG. 3 shows a further method 300 according to the present invention. The first step 302 comprises adjusting the power of both eyes' variable focus lenses to achieve optimum acuity for both eyes.

Step 304 of the present method comprises defining a scheme for the preferred and lazy eyes' shutters, where the scheme comprises alternating the shutters between two different opacities at a frequency of 10 Hz. The shutters are alternated such that the preferred eye's shutter is transparent when the lazy eye's shutter is opaque and vice versa. In the present embodiment the duration of transparency and opacity of each shutter is the same, but it will be appreciated that in other embodiments unequal durations could be used, for example so that the lazy eye shutter is transparent for a longer duration than the time for which it is opaque. The switching frequency is sufficiently low (below that it which the brain cannot detect flicker) that the brain is encouraged to process signals from both eyes individually.

At step 306, the patient wears the glasses with the scheme applied for one hour. At the end of one hour, at step 308, both shutters are set to a continuous transparency.

At step 310, the patient then wears the glasses with both shutters continuously transparent and both variable lenses set at a power corresponding to optimum acuity of both eyes for 23 hours. The patient may remove the glasses for certain activities, e.g. sleeping. It will be appreciated that steps 306, 308 and 310 comprise a daily routine involving one-hour of treatment while the scheme is applied to the glasses, followed by 23 hours of non-treatment.

For an amblyopic treatment procedure, it is desirable to repeat this daily routine for a number of days. Thus, at step 312, it is determined whether or not a period of one week of daily treatments has elapsed. If one week has not yet been reached, the method returns to step 306 for a repetition of the daily procedure. If a period of one week since the start of treatment has elapsed, the method proceeds to step 314 at which the refractive error and acuity of the lazy eye are measured. At step 316 a determination is made of whether there has been a significant improvement in the lazy eye.

If there has been no improvement, the method proceeds to step 318 at which it is determined whether the length of the treatment has reached two weeks. If two weeks of daily treatments have not elapsed, the method proceeds to step 320 at which an alternative scheme is defined in which the shutters are alternated at a frequency of 1 Hz. The method then proceeds to step 306, thus recommencing a daily routine of one hour's treatment per day at the new frequency.

If at step 316 it is determined that there has been a significant improvement in the lazy eye, the method proceeds to step 306 and a further week of treatment is conducted at a frequency of 10 Hz. This is then repeated for as long as a significant improvement in the lazy eye is observed. In the case that no improvement was observed after the first week and the method advanced to step 320 at which the frequency was changed to 1 Hz, if the lazy eye shows an improvement then the daily routine is continued for one or more further weeks at 1 Hz for as long as a significant improvement is observed in the lazy eye. When step 316 is reached and no significant improvement has been observed, the method proceeds to step 318. If the total number of weeks treatment has reached two weeks, and no significant or no further significant improvement has been observed in the lazy eye, the treatment is discontinued.

If no improvement has been seen in the lazy eye at all, then the medical practitioner may consider alternative means of treatment for the patient.

FIG. 4 shows a further method 400 for treating amblyopia according to the present invention. The first step 402 comprises adjusting the power of the variable focus lens of the preferred eye to achieve optimum acuity of the preferred eye.

The second step 404 of the method comprises determining an optimum power corresponding to an optimum acuity of the lazy eye.

At step 406, a maximum power pₘₐₓ and a minimum power pₘᵢₙ are specified. In the present embodiment pₘₐₓ is 3 dioptres above the optimum power pₒₚₜ, and the minimum power pₘᵢₙ is 3 dioptres less than the optimum power pₒₚₜ. A frequency f is specified. In the present embodiment the frequency f is five sweeps per minute. This corresponds to an average sweep rate of one dioptre per second. However, it will be appreciated that other power ranges and other frequencies may be used.

The method proceeds to step 408 in which the preferred eye is patched, e.g. by setting a shutter to an opaque state (although a different type of patch could be used if shutter glasses are not used in this process).

In step 410 the power of variable focus lens of the lazy eye is swept sinusoidally from pₘₐₓ to pₘᵢₙ and back to pₘₐₓ at frequency f while the patient wears the glasses. It will be appreciated that the power could be changed in some other way other than sinusoidally, for example, in discrete steps, or continuously and linearly. While the power is swept, the patient attempts to view symbols on a wall chart. It has been observed that providing means to encourage the use of the lazy eye and/or concentration of the patient during treatment can enhance the rate at which the lazy eye improves.

The idea behind sweeping the power of the variable focus lens for the lazy eye is that viewing an image as it is swept in and out of focus at the retina of the lazy eye should serve to trigger the eye-brain feedback system into its normal function, thus encouraging the brain to re-establish control over the lazy eye, e.g. gaining improved control over the cilliary muscle.

At step 412, the patch is removed. At step 414 the power of the lazy eye's variable focus lens is adjusted to achieve optimum acuity. Steps 408, 410, 412 and 414 comprise a treatment procedure 416. At the end of procedure 416, it is determined at step 418 whether procedure 416 has been applied fourteen times. If the procedure has not yet been applied 14 times, the method proceeds to step 420 in which 24 hours since the start time of the most recent application of procedure 416 is allowed to elapse. The method then proceeds to step 408 to repeat procedure 416.

Once the procedure 416 has been applied 14 times, the method proceeds to step 422 at which the refractive error and acuity of the lazy eye are measured. If there has been a significant improvement in the lazy eye, the method proceeds to step 420 and then to step 408 for a further 14 applications of the procedure. If there has been no improvement in the lazy eye the method proceeds to step 426, at which step it is determined whether the procedure 416 has been applied 28 times. If the procedure has not yet been applied 28 times, the method proceeds from step 424 to step 420, at which a further 24 hours is allowed to elapse and then the procedure 416 is repeated a further 14 times. If an improvement is observed at step 424, the procedure is repeatedly applied until no further improvement is seen in the lazy eye.

If no improvement has been observed and the procedure has been applied 28 times (i.e. a daily procedure every day for 28 days) the treatment is discontinued. If no improvement has been seen at all during the 28 days, the medical practitioner may consider alternate means of treatment for the patient.

It will be appreciated that the variables that can be adjusted for optimising the sweeping treatment process include the rate of sweep of power of the variable lens, the number of sweeps, the duration of the whole sweep cycle and the range of power through which the lens is swept.

FIG. 5 shows an alternative procedure 500 that can be used in the place of procedure 416 in FIG. 4.

The alternative procedure 500 combines the shutter-based daily routine depicted in FIG. 3 with a subsequent power-sweeping method according to procedure 416 in FIG. 4.

In procedure 500, at a first step 502 the power of both eyes' variable focus lenses are adjusted to achieve optimum acuity. At step 504 a pattern of alternating opacities of the shutters at 10 Hz is applied. At step 506 the patient wears the glasses with the pattern applied for one hour and at step 508, after one hour has elapsed, the lazy eye's shutter is set to a continuous transparency, and the preferred eye is patched at step 510 by setting the preferred eye's shutter to a continuous opaque state. Steps 502 to 510 corresponds to the daily routine applied in FIG. 3, ending with the preferred eye being patched.

At step 512 the variable focus lens of the lazy eye is swept 100 times sinusoidally from pₘₐₓ to pₘᵢₙ to pₘₐₓ at frequency f (as defined in method 400) while the patient wears the glasses and attempts to view symbols on a wall chart. At step 514 the shutters are both set to continuous transparency. At step 516 the power of the lazy eye's variable focus lens is adjusted to achieve optimum acuity. Steps 512, 514 and 516 corresponds to procedure 416 as depicted in FIG. 4.

At step 518 the patient then wears the glasses for the remainder of the day with both shutters continuously transparent and both lenses set to optimum acuity.

FIG. 6 shows a further alternative procedure 600 in which the shutter-based method of FIG. 3 is employed simultaneously with the power-sweeping method of procedure 416 in FIG. 4.

In a first step 502 the power of both eyes' variable focus lenses are adjusted to achieve optimum acuity. At step 504 a scheme of alternating opacities is applied to the shutters at a frequency of 10 Hz. At step 506, while the shuttering scheme is maintained in operation, the power of the lazy eye's variable focus lens is swept sinusoidally 100 times from pₘₐₓ to pₘᵢₙ and back to pₘₐₓ at frequency f while the patient wears the glasses and attempts to view symbols on a wall chart.

At step 508 both shutters are set to continuous transparency, and at step 510 the lazy eye's variable focus lens is set to optimum acuity. The patient then continues at step 512 to wear the glasses with the shutters continuously transparent and both lenses at optimum acuity for the remainder of the day.

It will be appreciated that the above methods are provided purely as examples and that other treatment procedures may be used according to further research and according to the particularly treatment circumstances, e.g. the age and willingness of the patient, the type and degree of amblyopia being treated. The above procedures (or variations thereof) may be combined.

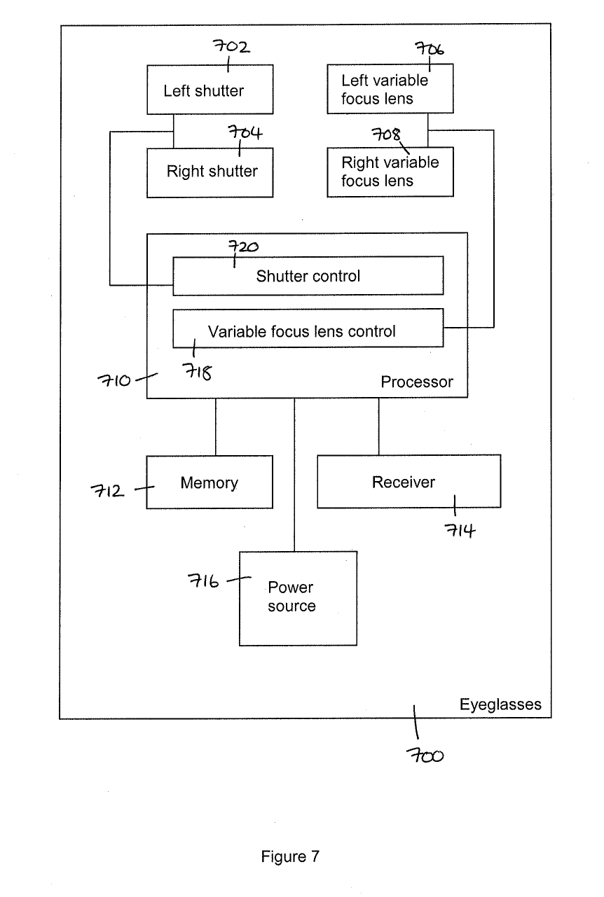

FIG. 7 schematically shows the various components of a preferred embodiment of eyeglasses 700 with left 702 and right 704 shutters and left 706 and right 708 variable focus lenses. The eyeglasses 700 comprise a processor 710 in communication with a memory 712, a receiver 714 (e.g. an IR receiver or wifi or bluetooth communication chip), and a power source 716 (e.g. a battery).

The processor 710 comprises a variable focus lens controller 718, which is in communication with and controls the left 706 and right 708 variable focus lenses. The processor 710 also comprises a shutter controller 720, which is in communication with and controls the left 702 and right 704 shutters.

The receiver 714 may receive signals from a remote transmitter, where the signal comprises instructions for schemes for operating the shutters 702, 704 and/or variable focus lenses 706, 708. The memory 712 may be used to store preset programmes or store information or instructions received from the receiver or via other input means provided on the eyeglasses 700. The eyeglasses 700 may thus be programmed by a user to operate according to one or more schemes.

From the above, it can be appreciated that in accordance with some preferred embodiments to assist the amblyopic patient in their treatment, it is helpful to provide both “patching”, e.g. using LCD eyeglasses where the transmissivity of either lens may be controlled by an applied voltage, and also, the ability for the patient to change the focus of either lens with a suitable adaptive (variable focus) lens whose power may be changed over an appropriate range, for example from +6 to −6 dioptres, though a higher positive or negative power might be provided. By this means, the brain may be “forced” to achieve a higher acuity for the amblyopic eye, which may then lead to almost completely normal vision if such a procedure is carried out sufficiently early.

1. A method of treating a patient with amblyopia using a pair of shutter glasses, the shutter glasses having first and second shutters and respective first and second variable focus lenses corresponding respectively to a lazy eye and a preferred eye of the patient, the method comprising:
adjusting a power of at least one of the first or second variable focus lenses;
controlling an opacity of the first shutter according to a first scheme;
controlling an opacity of the second shutter according to a second scheme;
adhering to the first and second schemes while the shutter glasses are worn by the patient during a treatment period.

2. A method as claimed in claim 1, wherein the first and second schemes comprise maintaining an opaque state in the second shutter and a non-opaque state in the first shutter for a duration greater than 0.05 seconds.

3. A method as claimed in claim 1 or 2, wherein at least one of the first and second schemes comprises switching between a first and second opacity at a fixed frequency.

4. A method as claimed in claim 3, wherein the first opacity is fully transparent and the second opacity is fully opaque.

5. A method as claim in claim 3 or 4, wherein the fixed frequency is between 1 and 10 Hz.

6. A method as claimed in any preceding claim, wherein the first scheme comprises maintaining the opacity of the first shutter at an opacity that is lower than an opacity of the second shutter for the duration of the treatment period.

7. A method as claimed in any preceding claim, wherein the first scheme comprises maintaining the first shutter in a non-opaque state for the duration of the treatment period.

8. A method as claimed in any preceding claim, wherein, the second scheme comprises maintaining the second shutter in an opaque or partially opaque state for the duration of the treatment period.

9. A method as claimed in any preceding claim, further comprising using the glasses to view stereoscopic media on a stereoscopic display.

10. A method as claimed in any preceding claim, further comprising adjusting the second variable focus lens to a power corresponding to a sub-optimal acuity of the preferred eye.

11. A method as claimed in claim 10, wherein the sub-optimum acuity is maintained during some or all of the treatment period.

12. A method as claimed in any preceding claim, wherein the power of the first variable focus lens is varied while at least one of the first and second schemes is maintained.

13. A method of treating a patient with amblyopia using a pair of glasses, the glasses comprising a variable focus lens corresponding to a preferred eye, the method comprising:
adjusting the variable focus lens to a power corresponding to a sub-optimal acuity of the preferred eye; and
maintaining the variable focus lens at the power corresponding to the sub-optimal acuity during some or all of a treatment period.

14. A method as claimed in claim 13, wherein the glasses further comprise a further variable focus lens corresponding to a lazy eye.

15. A method as claimed in any of claims 10 to 14, wherein the sub-optimal acuity set for the preferred eye is worse than an optimal acuity of the lazy eye.

16. A method as claimed in any preceding claim, further comprising varying the power of the variable focus lens corresponding to the lazy eye during the treatment period.

17. A method of treating a patient with amblyopia using a pair of glasses, the glasses comprising a variable focus lens corresponding to a lazy eye, the method comprising varying a power of the variable focus lens during a treatment period.

18. A method as claimed in claim 17, wherein the glasses also comprise a variable focus lens corresponding to a preferred eye.

19. A method as claimed in any of claims 12 or 16 to 18, further comprising obscuring or penalising the preferred eye while the power of the variable focus lens is varied.

20. A method as claimed in any of claims 12 or 16 to 19, wherein the power of the variable focus lens is varied continuously.

21. A method as claimed in any of claims 12 or 16 to 20 wherein the variable focus lens is varied between a power lower than a best corrective power for the lazy eye and a power higher than the best corrective power.

22. A method as claimed in any of claims 12 or 16 to 21, wherein the power of the variable focus lens is varied over a range of about six dioptres.

23. A method as claimed in any of claims 12 or 16 to 21, wherein the power of the variable focus lens is varied over a range of less than six dioptres.

24. A method as claimed in any of claims 12 or 16 to 21, wherein the power of the variable focus lens is varied over a range of greater than six dioptres.

25. A method as claimed in any of claims 12 or 16 to 24, wherein the power of the variable focus lens is varied over a range that is symmetric about the best refractive power.

26. A method as claimed in any of claims 12 or 16 to 24, wherein the power of the variable focus lens is varied over a range that is asymmetric about the best refractive power.

27. A method as claimed in any of claims 12 or 16 to 26, wherein the power of the variable focus lens is varied at an average rate of about one dioptre per second.

28. A method as claimed in any of claims 12 or 16 to 27, wherein the power of the variable focus lens is varied from a maximum value to a minimum value between 50 and 150 times in a treatment procedure.

29. A method as claimed in claim 28, comprising repeating the treatment procedure periodically.

30. A method as claimed in any preceding claim, wherein the treatment period comprises a single continuous period.

31. A method as claimed in any preceding claim, wherein the treatment period comprises a continuous period that is subsequently repeated during an extended period.

32. A method as claimed in any preceding claim, wherein the patient partakes in an activity for encouraging use of the lazy eye or encouraging concentration of the patient during some or all of the treatment period.

33. A method as claimed in any preceding claim, further comprising adjusting the glasses for use as conventional corrective eye glasses when they are not used for treating amblyopia.

34. A method as claimed in any preceding claim, wherein the or each variable focus lens comprises at least one of a fluid filled lens, an Alvarez-based lens, an electro-active lens, a diffractive lens or a diffractive Alvarez lens.

35. A method as claimed in any preceding claim, wherein the or each variable focus lens is provided with one or more fixed power lens elements.

36. A pair of shutter glasses for treating amblyopia, comprising:
a first shutter corresponding to a lazy eye, the glasses being configurable to control an opacity of the first shutter according to a first scheme;
a first variable focus lens corresponding to the first shutter;
a second shutter corresponding to a preferred eye, the glasses being configurable to control an opacity of the second shutter according to a second scheme; and
a second variable focus lens corresponding to the second shutter; wherein
at least one of said first and second schemes comprises maintaining an opaque state or a non-opaque for a duration greater than 0.05 seconds.

37. A pair of glasses for treating a patient with amblyopia, the glasses comprising:
a variable focus lens corresponding to a lazy eye;
controlling means configurable to automatically vary a power of the variable focus lens during a treatment period.

38. A pair of glasses as claimed in claim 37, wherein the controlling means is programmable.

39. A pair of glasses as claimed in claim 37 or 38, wherein the glasses also comprise a variable focus lens corresponding to a preferred eye.

40. A pair of glasses as claimed in any of claim 37, 38 or 39, further comprising means for obscuring or penalising the preferred eye while the power of the variable focus lens is varied.

41. A pair of glasses as claimed in any of claims 37 to 40, wherein the controlling means is configured to vary the power of the variable focus lens continuously.

42. A pair of glasses as claimed in any of claims 37 to 41, wherein the controlling means is configured to vary the power of the variable focus lens between a power lower than a best corrective power for the lazy eye and a power higher than the best corrective power.

43. A pair of glasses as claimed in any of claims 37 to 42, wherein the controlling means is configured to vary the power of the variable focus lens over a range of about six dioptres.

44. A pair of glasses as claimed in any of claims 37 to 42, wherein the controlling means is configured to vary the power of the variable focus lens over a range of less than six dioptres.

45. A pair of glasses as claimed in any of claims 37 to 42, wherein the controlling means is configured to vary the power of the variable focus lens over a range of greater than six dioptres.

46. A pair of glasses as claimed in any of claims 37 to 45 wherein the controlling means is configured to vary the power of the variable focus lens over a range that is symmetric about the best refractive power.

47. A pair of glasses as claimed in any of claims 37 to 45, wherein the controlling means is configured to vary the power of the variable focus lens over a range that is asymmetric about the best refractive power.

48. A pair of glasses as claimed in any of claims 37 to 47, wherein the controlling means is configured to vary the power of the variable focus lens at an average rate of about one dioptre per second.

49. A pair of glasses as claimed in any of claims 37 to 48, wherein the controlling means is configured to vary the power of the variable focus lens from a maximum value to a minimum value between 50 and 150 times in a treatment procedure.

50. A pair of glasses as claimed in any of claims 36 to 49, wherein the or each variable focus lens comprises at least one of a fluid filled lens, an Alvarez-based lens, an electro-active lens, a diffractive lens or a diffractive Alvarez lens.

51. A pair of glasses as claimed in any of claims 36 to 50, wherein the or each variable focus lens is provided with one or more fixed power lens elements.
